(19) United States
(12) Patent Application Publication
(10) Pub. No.: US 2005/0195932 A1
(43) Pub. Date: Sep. 8, 2005

(54) Method and device for promptly conducting non-destructive chemical analysis of test objects

(76) Inventors: Uwe Keyser, Braunchweig (DE); Annette Rottger, Wedtlenstedt (DE); Stefan Rottger, Wedtlenstedt (DE); Andreas Zimbal, Braunschweig (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/509,909

(22) PCT Filed: Apr. 2, 2003
(86) PCT No.: PCT/DE03/01084

§ 371 Date: Apr. 7, 2005

(30) Foreign Application Priority Data
Apr. 5, 2002 (DE) 10215070.2

(51) Int. Cl. G21G 1/06

(52) U.S. Cl. 376/159

(57) ABSTRACT

The invention relates to a method for conducting non-destructive chemical analysis of test objects (1) by irradiating the test object (1) with neutrons and measuring the quantity of gamma photon radiation, which is emitted by the test object (1) immediately after irradiation, based on the number of gamma photon quanta of the respective photon energy (E_{γ}) in order to record a photon energy spectrum (6). The inventive method has the following steps: determining characteristic photon energies (E_{γ}) based on the gamma photon radiation quantities of the photon energy spectrum (6) which exceed a background photon radiation, and; determining the elements and/or isotopes of the test object (1) by assigning the characteristic photon energies (E_{γ}) to corresponding elements and/or isotopes that are each stored distinctly at a photon energy (E_{γ}).

The invention relates to a method for the non-destructive chemical analysis of test objects by means of irradiating the test object with neutrons generated by target-free fusion of concentrically accelerated deuterium ions and measuring the amount of gamma photon radiation emitted promptly by the test object during the irradiation from the number of gamma photon quanta and the respective photon energy in order to record a photon energy spectrum.

The invention further relates to a device for the non-destructive chemical analysis of test objects, comprising a neutron source for briefly irradiating the test object with neutrons generated by target-free fusion of concentrically accelerated deuterium ions and comprising at least one photon detector aimed at the test object in order to measure the quantity or gamma photon radiation emitted promptly by the test object immediately after the irradiation from the number of gamma photon quanta and the respective photon energy.

In order to determine element and concentration, for example WO 01/07888 A2 and U.S. Pat. No. 5,539,788 disclose neutron activation analysis as a nuclear physics analysis method, artificial radioactive nuclides being generated to a small extent by means of irradiation of stable nuclides with neutrons. During the subsequent beta decay of the nuclides produced, electrons are emitted and the gamma spectrum of the neutron-activated material to be analyzed is measured. Element concentrations can be determined very accurately from the gamma spectrum. During neutron activation analysis, however, a high requisite neutron density in or on a reactor core and, associated with this, intense activation of the test object are disadvantageously required. In addition, stable elements cannot be detected, with the exception of the last stable isotope and if the half-life is sufficiently long, since these are converted into a different isotope or element after absorbing a neutron during activation.

Methods for the analysis of substances with the aid of neutron activation analysis are described, for example, in U.S. Pat. No. 5,982,838 and DE 197 45 669 A1. In this case, the recorded energy spectrum is determined by means of assigning lines and calculating areas from specific energy regions.

In Tsahi Gozani: Novel applications of fast neutron interrogation methods in: Nuclear Instruments & Methods in Physics Research A 353 (1994) 635 to 640, a method is described for the γ-spectral analysis of items of luggage with neutron activation analysis using 14 MeV neutrons. Here, too, spectra are examined which are based on the nuclear reactions with the formation of now radionuclides or isomers on account of the neutron activation.

In order to determine the contamination of a silicon sphere, A. Paul, S. Röttgar, A. Zimbal and U. Keyser: “Prompt (n, γ) Mass Measurements for the AVOGADRO Project” in: Hyperfine Interactions 132:189-194, 2001 discloses subjecting a silicon sample to be examined at the end of a curved neutron conductor at a large distance from a reactor core to the parallel beam of thermal neutrons with a known flux density (E<25 meV). In the material sample, the thermal neutrons are captured and effect very high internal excitation of the atomic nuclei involved. This results in the immediate rearrangement of the nucleons into the new, energetically most favorable state. The excess energy is discharged by means of the prompt emission of electromagnetic radiation in the form of characteristic photon quanta. From the number of photon quanta per photon energy, a photon energy spectrum (n, γ spectrum) is measured and the molar mass of the silicon sphere is determined from the photon radiation energy emitted. However, chemical analysis of the test object is not carried out.

For the purpose of chemical analysis of test objects in order to determine the elements and/or isotopes, destructive analysis methods are conventionally used. During the measurement, therefore, samples can be examined for the presence of individual elements or isotopes only in a relatively complicated manner.

It was therefore an object of the invention to provide an improved method for the non-destructive chemical analysis of test objects with which, very simply and as quickly as possible, all the elements and/or isotopes present in a test object can be determined.

According to the invention, the object is achieved by the generic method by means of
determining characteristic photon energies from the amounts of gamma photon radiation from the entire photon energy spectrum which exceed background photon radiation, at least as far as the region of 12 MeV, and
determining the elements and/or isotopes of the test object by assigning the characteristic photon energies distributed over the entire photon energy spectrum to corresponding elements and/or isotopes which are in each case stored unambiguously in relation to a photon energy.

Surprisingly, it has transpired that, in a photon energy spectrum obtained by excitation with low-energy neutrons (2.45 MeV), each isotope can be assigned at least one characteristic photon energy unambiguously if the entire photon energy spectrum is considered, at least as far as the region of 12 MeV. Following the acquisition of all the isotopes present and the corresponding photon energies, it is therefore possible to determine the elements and isotopes present in a test object from a recorded photon energy spectrum by means of evaluating the characteristic photon energies. The photon energy spectra determined at up to 12 MeV by, the method according to the invention are therefore complete, since spectra which are produced on the far side of this order of magnitude can no longer be attributed to the neutron irradiation. The reason for this is the binding energies in the atomic nuclei.

The excitation of low-energy neutrons is ensured by target-free fusion of concentrically accelerated deuterium ions. This ensured that virtually no nuclear reaction takes place with the formation of new radionuclides or isomers, as in the case of the abovedescribed prompt neutron activation analysis methods. The resultant photon energy spectra are therefore not comparable with one another. In the case of the photon energy spectrum obtained by excitation with low-energy neutrons, it has been shown that, for each isotope, characteristic energy lines are distributed over the entire photon energy spectrum. As distinct from the prior art, in which only an extract of a photon energy spectrum is examined for characteristic energy lines, in the method according to the invention an analysis of the entire photon energy spectrum is carried out. In this case, all the characteristic energy lines of an isotope are taken into account, since these are distributed over the entire photon energy spectrum. In this way, an unambiguous analysis is possible. In addition, virtually no excitation and conversion of the isotopes examined takes place on account of the irradiation.

The method has the advantage that all isotopes which occur in nature can be detected. In addition, it is merely necessary for the test object to be irradiated without prior sample preparation being necessary. The sample geometry and the overall state of the test object are in addition any desired.

By means of recording a complete photon energy spectrum by means of multichannel measurement, in addition all the isotopes are measured at the same time, so that a comprehensive chemical analysis can be conducted very quickly. Because of the quantum-physics relationship of the photon energy E with the frequency of light f (E=h×f, where h=Planck's constant), the photon energy spectrum corresponds to a recorded light frequency spectrum.

Furthermore, a quantitative determination of the chemical composition of the test object can preferably be carried out by means of measuring the complete measurable range of the gamma photon energy spectrum and determining the proportions of elements and/or isotopes determined by relating the amount of gamma photon radiation per element and/or isotope to the entire amount of gamma photon radiation determined for all the characteristic photon energies determined.

The number of photon quanta of the individual characteristic photon energies, which stand out from the curve of the recording photon energy spectrum as pulse peaks, are thus normalized, and the percentage distribution of the elements or isotopes determined in the entire mass of the test object can be calculated in a simple way.

The amounts of photon radiation are preferably determined, for example, with known methods for measurement curve processing by determining the areas of the characteristic pulse curves of the photon energy spectrum in the regions of the characteristic photon energies. Thus, pulse peaks exceeding the base curve of the photon energy spectrum are detected and the areas under these pulse peaks are calculated.

In order to neutralize the influences of the test environment, a base photon energy spectrum of the test chamber without the test object is recorded and a photon energy spectrum used for evaluation is calculated from the difference between the photon energy spectrum recorded for the analysis and the base photon energy spectrum.

It is particularly advantageous to irradiate sections of the test object from a plurality of directions and to evaluate the plurality of test results for the purpose of location-dependent analysis of the test object. In this way, the test object is scanned in a manner comparable with a tomography device and supplies a three-dimensional local resolution of the isotope or element concentration.

On account of the short irradiation times and the low requisite energy of the thermal neutrons of E<25 meV, the test objects are not affected in a damaging way, so that the method can also be used, for example, for the examination of living objects.

Furthermore, the object is achieved by the generic device, in which the neutron source is a neutron generator arranged beside the test object. Coupled to the at least one photon detector is an evaluation computing unit, which is designed to determine characteristic photon energies from the amounts of gamma photon radiation from the photon energy spectrum which exceed a background photon radiation and to determine the elements and/or isotopes of the test object by assigning the characteristic photon energies to the corresponding elements and/or isotopes in each case stored unambiguously in relation to a photon energy.

As distinct from the known devices, a compact, preferably mobile, neutron generator is thus used instead of a research reactor. The chemical analysis can in this way be used for the first time in test laboratories and in direct production operation. For example, the quality and composition of mass-produced goods on a conveyor belt can be monitored continuously with the aid of the device, it being possible for the streams of mass-produced goods to be deflected on the basis of quality.

Furthermore, it is advantageous if the at least one photon detector is shielded by means for the absorption of neutrons. In this way, the scattering influence of photons which are not emitted by the test object can be reduced and the photon detector can be aimed as accurately as possible at the test object.

Furthermore, a focusing element, which is designed for the thermal adaptation of the neutrons, is preferably provided between the neutron generator and the test object. In this way, the neutron velocity is matched, for example, to the Brownian movement of the air, so that there are virtually only thermal neutrons in the neutron beam.

The focusing element can, for example, be constructed as a neutron-absorbing plate having a passage hole.

A suitable material for the shielding of the neutron detector and the focusing element is all materials having a high neutron capture cross section.

The invention will be explained in more detail below using the appended drawings, in which:

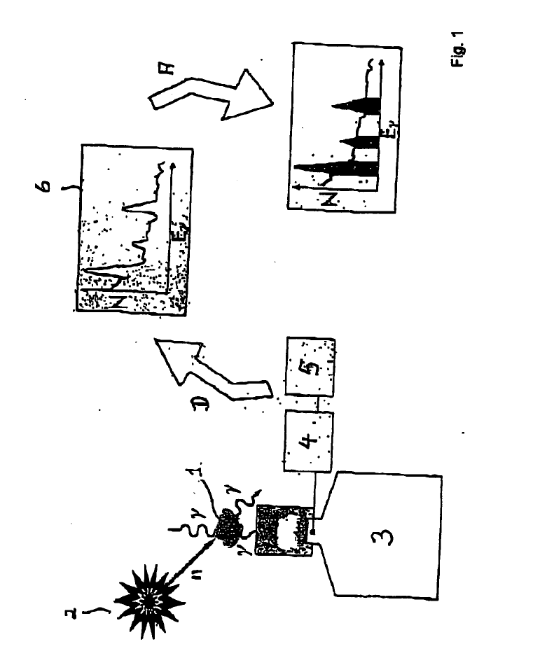

FIG. 1 shows a basic block diagram of the method according to the invention for non-destructive chemical analysis;

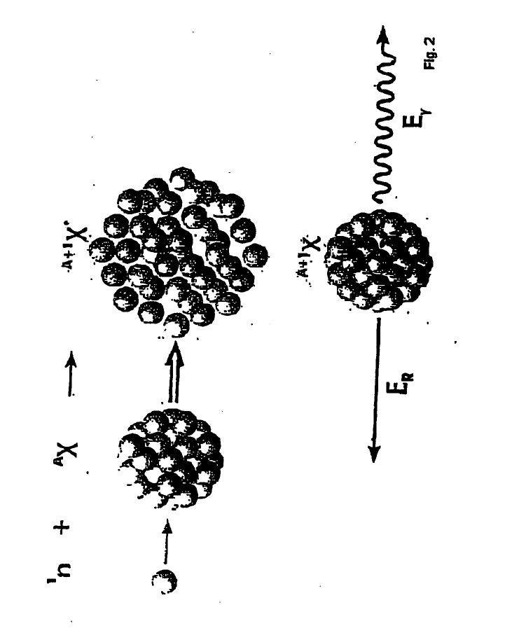

FIG. 2 shows a schematic illustration of the penetration of a neutron into an atomic nucleus and the emission of gamma photon energy;

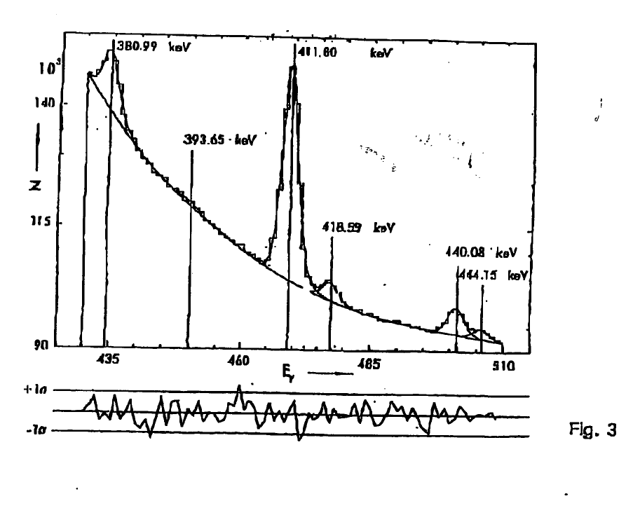

FIG. 3 shows an extract from a recorded gamma photon energy spectrum;

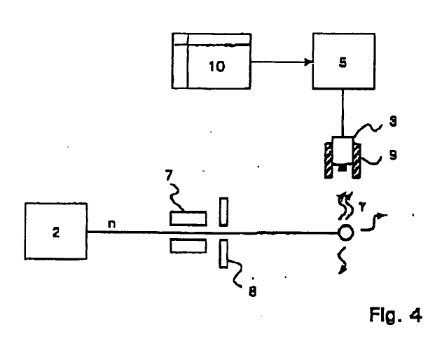

FIG. 4 shown a block diagram of a device according to the invention for non-destructive chemical analysis.

FIG. 1 reveals a schematic block diagram of the method according to the invention for the non-destructive chemical analysis of test objects 1. With the aid of a neutron source 2 arranged in the vicinity of the test object 1, the test object 1 is irradiated, briefly or continuously, with neutrons n, which in each case penetrate into the atomic nuclei. In this case, gamma photon energy E_{γ} is emitted. Some of the gamma photon quanta emitted are measured by a gamma photon detector 3 and conducted via test electronics 4, known per se, to an evaluation computing unit 5.

There, in a data recording step D, a photon energy spectrum 6 is recorded first, by the number N of photon quanta being plotted against the respective photon energy E_{γ}.

In an evaluation step A, characteristic photon energies E_{γ} are determined as the amount of gamma photon radiation from photon energy spectrum 6 which exceeds a background photon radiation, by the pulse peaks being detected, for example by means of known signal curve evaluation methods. From the characteristic photon energies E_{γ} the elements and/or isotopes present in the test object 1 are then determined by means of assignment to the corresponding known elements and/or isotopes respectively stored unambiguously in relation to a photon energy.

It is further possible to see that the areas underneath the characteristic pulse curves of the photon energy spectrum in the regions of the characteristic photon energies E_{γ} are determined. By means of normalizing the areas, the proportions of the elements in the total mass of the test object 1 can be determined very accurately, since the photon energy spectrum 6 recorded takes into account all the elements and/or isotopes.

Therefore, with a single measurement, a complete chemical analysis of the test object 1 can be conducted without the test object 1 having to be prepared or an examination for the presence of individual elements or isotopes being necessary.

FIG. 2 reveals a schematic representation of the basic physical principle on which the method is based. When a neutron n penetrates into an atomic nucleus ^{A}X, the atomic nucleus ^{A+1}X* iv excited intensely. This results in an immediate rearrangement of the nucleons into a new, energetically most favorable state ^{A+l}X, the excess energy being discharged by means of the prompt emission of electromagnetic radiation in the form of characteristic gamma photon quanta with a gamma photon energy E_{γ}. The gamma photon energy E_{γ} is the difference between the binding energy E_{B} and the reconversion energy E_{R} needed to assume the now state of the atomic nucleus.

The prompt process illustrated lasts for at most 10⁻¹⁷ seconds from the penetration of the neutron into the atomic nucleus.

FIG. 3 reveals an exemplary gamma photon energy spectrum recorded by the method and having characteristic pulse curves at characteristic photon energies of 380.99 keV, 393.65 keV, 411.90 keV, 418.59 keV, 440.08 keV and 444.15 keV. The photon number N is determined from the areas lying underneath these characteristic pulse curves.

Assuming that the photon energy spectrum is complete, by means of normalizing the individual amounts of photons per characteristic photon energy E_{γ}, a proportion of the associated element in the total mass of the test object 1 can additionally be calculated, since the pulse heights reproduce all the elements or isotopes present in the test object 1, and the sum of the areas of the characteristic pulse curves determined make up the complete mass (100%) of the test object 1. The standard deviation associated with the photon energy spectrum is plotted underneath the graph.

FIG. 4 reveals a block diagram of a device according to the invention for non-destructive chemical analysis of a test object 1. Arranged in the vicinity of the test object 1 is a preferably portable neutron generator 2, whose neutron beam n is aimed at the test object 1. Between the neutron generator 2 and the test object 1 there is a neutron moderator 7, in order to adapt the neutron velocity so as to produce thermal neutrons n which are matched to the Brownian movement of the air, and a focusing means 8 in order to focus the neutron beam n.

Arranged adjacent to the test object 1 is a gamma photon detector 3, which is aimed at the test object 1 and is designed to record a photon energy spectrum. With the aid of a multichannel measurement, the number of photon quanta is thus measured as a function of the respective photon energy E_{γ} or the light frequency v of the photons and supplied to an evaluation computing unit 5. The at least one photon detector 3 is provided at the side with shielding 9 in order to reduce the influences of interfering radiation.

Suitable as the material for the neutron moderator 7, the focusing means 8 and the shielding 9 are all materials having a low atomic number and a small capture cross section, for example polyethylene to which a catalyst has been added. The focusing means 7 is formed, for example, as a plate having a hole.

The evaluation computing unit 5 is, for example, designed by means of programming to determine the characteristic photon energies E_{γ} from amounts of photon radiation from the photon energy spectrum that exceed a background photon radiation, by means of signal analysis. The evaluation computing unit 5 makes access to a stored table 10, in which the characteristic photon energies E_{γ} of all known isotopes and therefore also elements are stored. By means of correlation with the characteristic photon energies E_{γ} determined with the photon energies E_{γ} stored in the table 10 for the isotopes, it in then possible to draw conclusions unambiguously from the photon energy spectrum about the chemical composition of the test object 1. By means of evaluating the limited amount of photons per characteristic photon energy E_{γ} it is additionally possible for the proportion of individual isotopes in the total mass under consideration to be determined highly accurately.

It is particularly advantageous if the test object 1 is scanned with the aid of a three-dimensional measurement, so that a location analysis can be carried out in a manner similar to that in a tomography method.

The invention can preferably be used wherever a qualitative and/or quantitative isotope or element detection of samples with any desired aggregate state and any desired geometry is concerned. This is the case in particular in prospecting for raw materials, material analysis, quality control and quality assurance, in the investigative and forensic sector (securing evidence, detecting traces), in the detection of weapons and explosives in airports and in pure substance analysis in the chemical industry.

1. A method for the non-destructive chemical analysis of test objects (1) by means of irradiating the test object (1) with neutrons n generated by target-free fusion of concentrically accelerated deuterium ions and measuring the amount of gamma photon radiation emitted promptly by the test object (1) during the irradiation from the number of gamma photon quanta and the respective photon energy (E_{γ}) in order to record a photon energy spectrum (6), characterized by
determining characteristic photon energies (E_{γ}) from the amounts of gamma photon radiation from the entire photon energy spectrum (6) which exceed background photon radiation, at least as far as the region of 12 MeV, and
determining the elements and/or isotopes of the test object (1) by assigning the characteristic photon energies (E_{γ}) distributed over the entire photon energy spectrum (6) to corresponding elements and/or isotopes which are in each case stored unambiguously in relation to a photon energy (E_{γ}).

2. The method as claimed in claim 1, characterized by quantitative determination of the chemical element composition of the test object (1) by means of measuring the complete measurable range of the photon energy spectrum (6) and determining the proportions of the elements and/or isotopes determined by relating the amount of gamma photon radiation per element and/or isotope to the entire amount of photon radiation determined for all the characteristic photon energies (E_{γ}) determined.

3. The method as claimed in claim 1, characterized by determining the amount of gamma photon radiation by determining the areas of the characteristic pulse curves of the photon energy spectrum (6) in the regions of the characteristic photon energies (E_{γ}).

4. The method as claimed in claim 1, characterized by recording a base photon energy-spectrum of the test chamber without the test object (1) and calculating a photon energy spectrum (6) used for evaluation from the difference between the photon energy spectrum (6) recorded for the analysis and the base photon energy spectrum.

5. The method as claimed in claim 1, characterized by irradiating sections of the test object (1) from a plurality of directions and evaluating the plurality of measurement results for the purpose of location-dependent analysis of the test object (1).

6. A device for the non-destructive chemical analysis of test objects (1), comprising a neutron source (2) for briefly irradiating the test object (1) with neutrons (n) and comprising at least one photon detector (3) aimed at the test object (1) in order to measure the quantity of gamma photon radiation emitted promptly by the test object (1) immediately after the irradiation from the number of photon quanta and the respective photon energy (E_{γ}), characterized in that the neutron source (2) is a neutron generator (2) arranged beside the test object (1) and an evaluation computing unit (5) is coupled to the at least one photon detector (3), the evaluation computing unit (5) being designed to carry out the method as claimed in claim 1.

7. The device as claimed in claim 6, characterized in that the neutron generator (2) is mobile.

8. The device as claimed in claim 6, characterized in that the at least one photon detector (3) is shielded by means for the absorption of neutrons (n).

9. The device as claimed in claim 6, characterized by a focusing element between the neutron generator (2) and the test object (1), the focusing element being designed for the thermal adaptation of the neutrons (n).

10. A computer program having program code means for carrying out the method as claimed in claim 1, when the computer program is executed on a computer.

11. The computer program as claimed in claim 10, having a database, characterized in that the database contains the characteristic photon energies (E_{γ}) of the elements and/or isotopes.

12. The computer program having program code means as claimed in claim 10, which are stored on a computer-readable data medium.

13. The database having a large number of entries of characteristic photon energies (E_{γ}) based on associated elements and/or isotopes for use in order to carry out the method as claimed in claim 1.
